(19) United States
(12) Patent Application Publication
(10) Pub. No.: US 2003/0215084 A1
(43) Pub. Date: Nov. 20, 2003

(54) Message server

(76) Inventors: Michael N. Obeso, Cincinnati, OH (US); Scott Lane, Cincinnati, OH (US)

Correspondence Address: William J. Harmon, III, Vierra Magen Marcus Harmon & DeNiro, LLP, Suite 540, 685 Market Street, San Francisco, CA, 94105-4206, US

(21) Appl. No.: 10/147,437

(22) Filed: May 16, 2002

(51) Int. Cl. H04M 3/42; H04M 1/00

(52) U.S. Cl. 379/355.01; 379/201.01

(57) ABSTRACT

A message server makes an automated dialing service available to remote client systems. The message server receives calling information from remote client systems through a network connection—identifying a set of telephone numbers, corresponding names, and a campaign identifier in one embodiment. The message server creates one or more calling packets, based on the calling information. The message server sends the calling packets to an automated dialer, which employs the information in the packets to make telephone calls and deliver the specified campaign. In one example, a calling packet includes the telephone numbers, corresponding names, and corresponding campaign identifier. In further embodiments, the message server also maintains and reports call related statistics to remote client systems.

### BACKGROUND OF THE INVENTION

1. Field of the Invention

The present invention is directed to the field of technology related to automated dialing.

2. Description of the Related Art

Many industries employ automated dialing technology to effectively reach large numbers of actual and prospective customers. Automated dialing hardware automates the dialing of multiple telephone numbers to deliver a common message. This helps avoid hiring a significant number of employees to place the desired calls.

Automated dialing systems, however, have not been adapted to support advances in communication technology. These advances enable remote offices within an organization to share resources over a network. Traditional automated dialing systems require duplicative data entry in an environment with remote users—requiring a dialing system administrator to manually regenerate lists of phone numbers provided by remote users.

In one example, a car company may want each of their dealerships to send a pre-recorded telephone message to each person that purchases a car. Using a traditional automated dialing system, each dealership may submit a list of telephone numbers to a dialing system administrator. The dialing system administrator manually enters the telephone numbers from each dealership into an automated dialer. Alternatively, each dealership could use a separate local automated dialer.

Neither of these scenarios is desirable. In the first scenario, the dialing system administrator is significantly burdened and may require a large support staff—increasing costs substantially and creating a system bottleneck. In the second scenario, the use of multiple dialers can increase costs. Multiple dialers also make it difficult to centrally coordinate a corporate wide campaign or maintain corporate wide statistics on calls.

### SUMMARY OF THE INVENTION

Embodiments of the present invention pertain to technology for providing access to automated dialing in a networked environment. One implementation of the present invention includes a message server computer system that makes an automated dialing service available to remote client systems.

One version of the message server receives calling information from remote client systems through a network connection. The calling information identifies a set of telephone numbers to be dialed. The calling information also includes corresponding names and a message identifier in some instances. In some embodiments, the message server provides clients with a customized web page interface for submitting calling information. In further embodiments, clients may employ the web page interface to update their configuration within the message server.

The message server creates one or more calling packets, based on the calling information. In one example, a calling packet includes the telephone numbers, corresponding names, and corresponding message identifier. The message server sends the calling packets to an automated dialer, which calls the telephone numbers listed in the calling packet and delivers the identified message. In further implementations, the message server also maintains and reports call related statistics.

When creating a calling packet, the message server formats the telephone numbers from the calling information. In one embodiment, the formatting operation includes: 1) stripping extra characters, 2) determining whether each telephone number has a valid number of digits, and 3) stripping out area code digits when appropriate. Some implementations of the message server also log and report formatting errors.

Aspects of the present invention can be accomplished using hardware, software, or a combination of both hardware and software. The software used for the present invention is stored on one or more processor readable storage media including hard disk drives, CD-ROMs, DVDs, optical disks, floppy disks, tape drives, RAM, ROM or other suitable storage devices. In alternative embodiments, some or all of the software can be replaced by dedicated hardware including custom integrated circuits, gate arrays, FPGAs, PLDs, and special purpose computers.

These and other objects and advantages of the present invention will appear more clearly from the following description in which the preferred embodiment of the invention has been set forth in conjunction with the drawings.

### BRIEF DESCRIPTION OF THE DRAWINGS

FIG. 1 illustrates a communications network including a message server in one embodiment of the present invention.

FIG. 2 depicts a functional block diagram of one embodiment of a message server.

FIG. 3 is a flowchart of process steps performed by the message server in one embodiment of the present invention.

FIG. 4 is a flowchart of process steps for one embodiment of providing a user interface.

FIG. 5 is a flowchart of process steps for one embodiment of providing automated dialing.

FIG. 6 is a flowchart of process steps for one embodiment of placing calls.

FIG. 7 is a flowchart of process steps for one embodiment of creating a calling packet.

FIG. 8 is a flowchart of process steps for one embodiment of formatting telephone numbers.

FIG. 9A is a flowchart of process steps for an alternate embodiment of placing calls.

FIG. 9B is a flowchart of process steps for a further embodiment of placing calls.

FIG. 10 is a flowchart of process steps for one embodiment of updating database information.

FIG. 11 is a flowchart of process steps for another embodiment of placing calls.

FIG. 12 is a flowchart of process steps for one embodiment of creating call related statistical reports.

FIG. 13 depicts one embodiment of a computer system that can serve as a message server.

### DETAILED DESCRIPTION

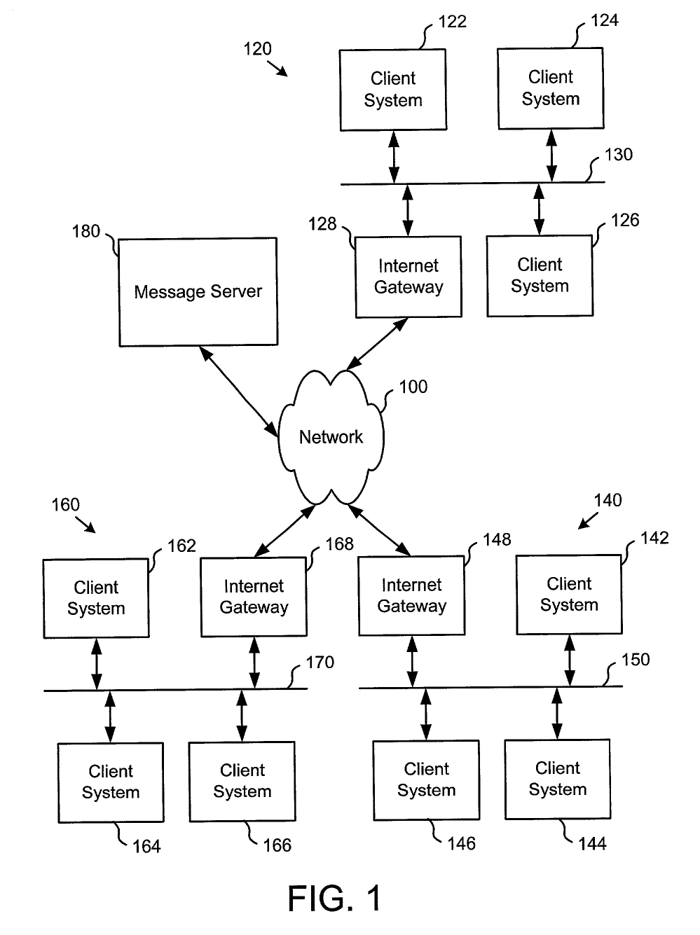

FIG. 1 shows message server 180 operating in network 100 in one embodiment of the present invention. Message server 180 facilitates an automated process for supporting telemarketing programs originating at client systems on sub-networks 120, 140, and 160. In one implementation, sub-networks 120, 140, and 160 reside within a logical network for a single organization—each sub-network corresponding to a car dealership of a common automobile manufacturer in one scenario. In an alternate implementation, sub-networks 120, 140, and 160 are unrelated. In various embodiments, different numbers of sub-networks can be employed.

Network 100 links message server 180 with sub-networks 120, 140, and 160. In one embodiment, network 100 is the Internet and sub-networks 120, 140, and 160 are separate local area networks (“LANs”), wide are networks (“WANs”), or alternate network configurations. Sub-networks 120, 140, and 160 are coupled to network 100 via Internet gateways 128, 148, and 168, respectively. In alternate embodiments, different enterprise network equipment can be employed to link sub-networks 120, 140, and 160 to network 100. Sub-networks 120, 140, and 160 employ communication mediums

130, 150, and 170, respectively, to link client systems and Internet gateways 128, 148, and 168, respectively. Medium 130 links client systems 122, 124, and 126 to Internet gateway 128 in sub-network 120. Medium 150 links client systems 142, 144, and 146 to Internet gateway 148 in sub-network 140. Medium 170 links client systems 162, 164, and 166 to Internet gateway 168 in sub-network 160.

Each client system is a computer system employed by sub-network users to exchange data with message server 180. Any computer system suitable for connection to a network can serve as a client system. One example is a personal computer with a network interface adapter. In various embodiments, different network architectures can be employed for sub-networks 120, 140, and 160 and different numbers of client systems can be used.

In alternate embodiments, different networking communication systems can be employed. For example, message server 180 can be employed on a LAN to service only the client systems residing on the LAN.

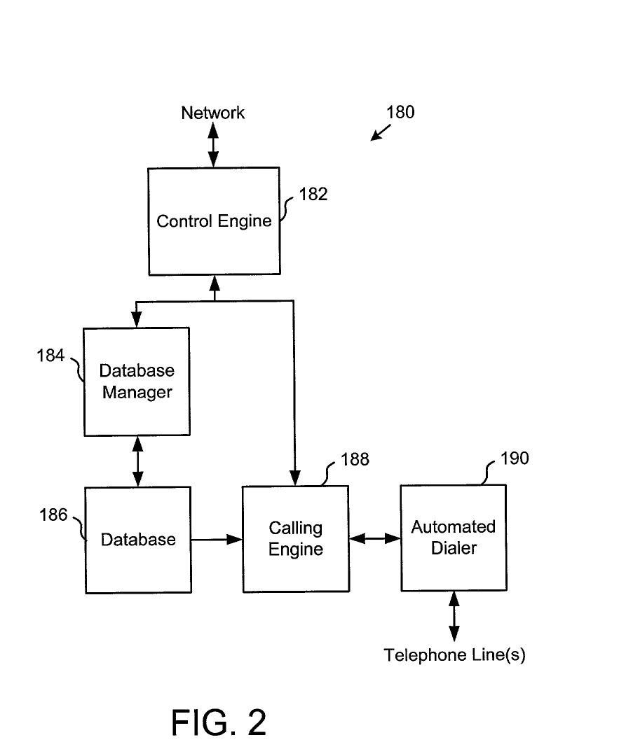

FIG. 2 depicts a functional block diagram for one implementation of message server 180. Control engine 182 controls the interface between message server 180 and network 100, including communications with the client systems on sub-networks 120, 140, and 160. Control engine 182 is coupled to database manager 184 and calling engine 188 to exchange data and instructions—allowing control engine 182 to direct the operation of database manager 184 and calling engine 188.

Database manager 184 is also coupled to database 186, which maintains data records to support automated dialing for the sub-network client systems. Greater details about these data records are provided below. Database manager 184 controls the storage and retrieval of data from database 186. In one embodiment, database manager 184 employs SQL queries when interfacing with database 186. In alternate embodiments, database manager 184 employs other database languages and protocols. Database 186 can be any type of database, such as a relational database.

Calling engine 188 is coupled to database 186 and automated dialer 190. Automated dialer 190 places telephone calls on one or more telephone lines that are connected to automated dialer 190. Automated dialers are well known in the art and many different devices are commercially available. In various embodiments of the present invention different automated dialers are employed.

Database manager 184 directs database 186 to provide call related information to calling engine 188. Calling engine 188 converts the call related data into a format suitable for automated dialer 190 and forwards the data to automated dialer 190. In one implementation, the call related information includes telephone numbers provided by the sub-network client systems and corresponding outgoing phone messages. Automated dialer 190 calls the telephone numbers and delivers the phone messages.

Alternate embodiments of message server 180 may not include database manager 184—control engine 182 and calling engine 188 directly interface with database 186. In further embodiments, automated dialer 190 is coupled to database 186 to receive data, with calling engine 188 facilitating the data transfer.

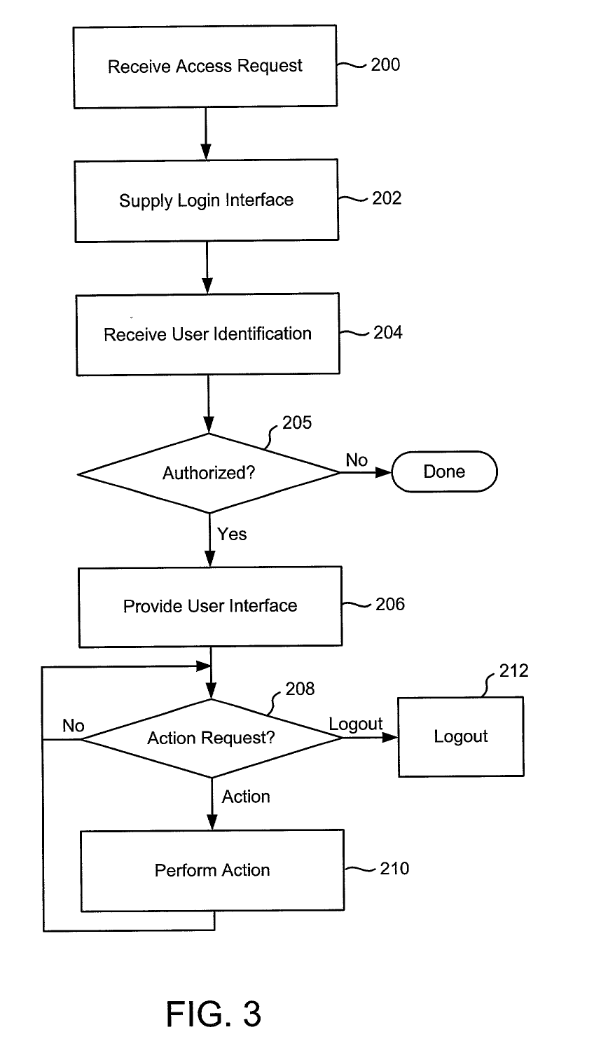

FIG. 3 shows one implementation of a process performed by message server 180 to support the client systems on sub-networks 120, 140, and 160. In various embodiments of the present invention, message server 180 employs different protocols to facilitate network communications and data exchanges with the client systems. One example protocol is Hypertext Transport Protocol (“http”). Example document formats include, but are not limited to, Hypertext Markup Language (“HTML”), Extensible Markup Language (“XML”), and combinations of HTML and XML.

Control engine 182 receives a request from a sub-network client system to access message server 180 (step 200). One example of an access request is a Universal Resource Locator (“URL”) containing a request to access message server 180. Control engine 182 responds to the access request by providing a login interface to the client system (step 202). One implementation of a login interface is a HTML or XML document that requests a set of identification information. A user name and password are one example of a set of identification information. In response to the supplied login interface, control engine 182 receives a set of identification information from the client system (step 204).

In further embodiments, message server 180 employs additional or different mechanisms to obtain a set of identification information. For instance, message server 180 may employ identification cookies.

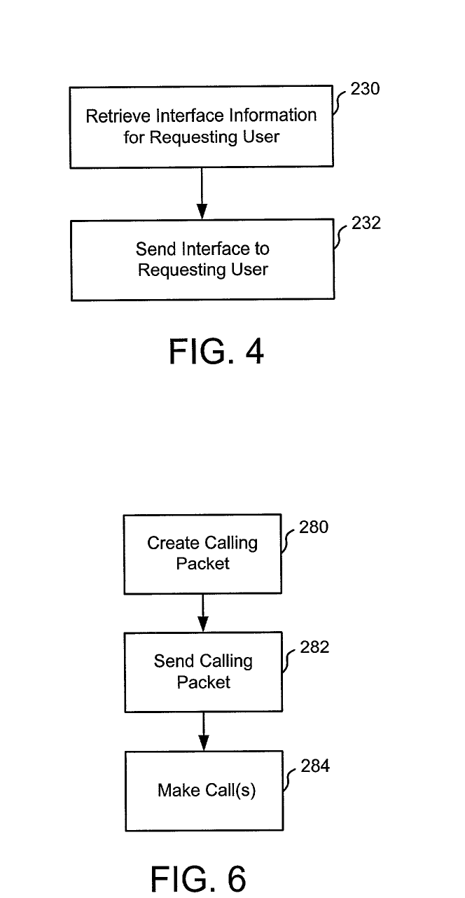

Control engine 182 determines whether the user requesting access through a client system is authorized to access message server 180 (step 205). Control engine 182 makes this determination based on the set of identification information. If the user requesting message server access is not authorized, the process terminates without granting any access. Otherwise, message server 180 provides the client system with a user interface (step 206). In one embodiment, message server 180 provides a customized user interface based on the set of identification information. This will be explained in greater detail later with respect to FIG. 4.

One implementation of a user interface includes fields for providing calling information. Further implementations may include fields for other data and instruction. One set of user interface fields provides for selecting categories and campaigns. Categories are used to classify types of telephone messages to be delivered. For example, if the client system is being used in a car dealership, there may be categories for the following: 1) car sold—for messages to people that recently purchased a car; 2) car not sold—for people that recently looked at a car but did not purchase the car; and 3) remarketing—for people that own cars needing service.

A campaign corresponds to a phone message—identifying the audible message to be delivered on the telephone and the format of the message. A campaign may contain a recorded voice message or a reference to a recorded voice message. Automated dialers often support multiple message formats, with example formats including the following: 1) playing the message; 2) only playing the message if an answering machine answers the phone call; and 3) playing a message and obtaining responses from the call recipient. Each category can have multiple associated campaigns. For the “car sold” category there may be campaigns that do the following: 1) leave the customer a message thanking him or her for the purchase; and 2) contact the customer and take a satisfaction survey over the phone.

The interface also has an input field that allows client system users to enter telephone numbers and corresponding names. As will be explained later, message system 180 receives and formats the telephone numbers and forwards them to automated dialer 190 for placing calls—avoiding the need for the telephone numbers to be manually entered into automated dialer 190.

The interface may also allow client system users to enter updates to database 186, such as modifying the categories and campaigns associated with the client system. This can include the ability to upload new categories and campaigns. In further implementations, the client system interface enables users to request reports about call related statistics. Details regarding database updates and statistical reports are provided below.

Once message server 180 provides the user interface (step 206), control engine 182 waits for the client system to submit an action request (step 208). The waiting process can be supported through polling or interrupt handling techniques. One type of action request calls for logging the client system out of its session with message server 180. In response to this type of request, message server 180 logs the client system out (step 212).

If another type of action is requested, message server 180 performs the requested action (step 210) and then waits for the next action request (step 208). Example actions include, but are not limited to, the following: 1) placing telephone calls to identified telephone numbers and delivering a prerecorded message; 2) updating user interface information or other information in database 186; and 3) generating statistical reports related to the telephone calls placed by message server 180.

In further implementations of message server 180, overlapping sessions with multiple client systems can be supported. In one such embodiment, each client system is assigned a separate thread of operation for the process steps shown in FIG. 3. In other embodiments, client system requests are processed serially in the order they're received or based on some other priority ranking criteria.

FIG. 4 shows one embodiment of a process for providing a user interface (step 206, FIG. 3). In this embodiment, message server 180 provides a customized user interface based on the set of identification information collected in step 204 (FIG. 3).

Message server 180 retrieves customized information for the user's interface, based on the set of identification information (step 230). Database manager 184 queries database 186 using the set of identification information—accessing customized information for the identified client system. In one example, the set of identification information includes a user name and password. Database manager 184 queries database 186 for user interface information corresponding to the user name and password combination. In one embodiment, the user interface information is a HTML or XML document containing categories and campaigns specific to the user. Control engine 182 uses the retrieved interface information to send the user interface to the client system accessing message server 180 (step 232).

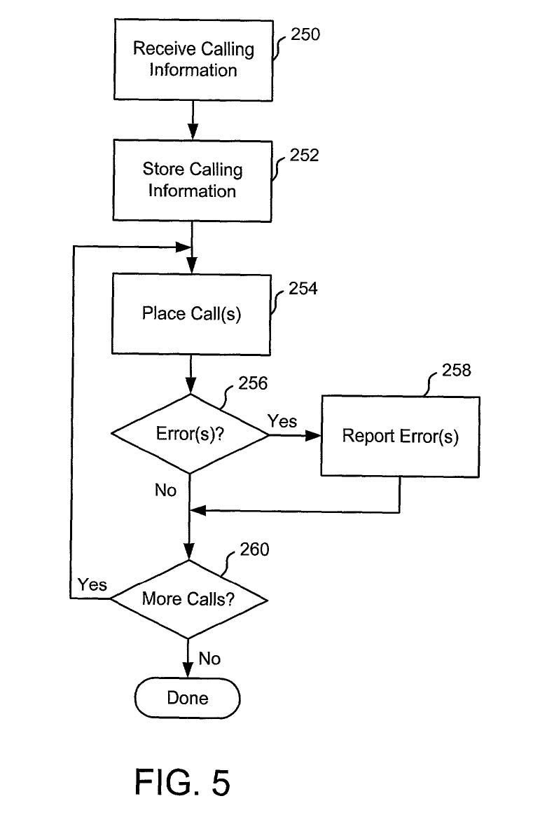

FIG. 5 shows one implementation of message server 180 performing an action for issuing telephone calls to telephone numbers identified by a client system. Message server 180 receives a set of calling information from a client system over a network, such as network 100 (step 250). In one implementation, a client system user sends the calling information over network 100 through the customized user interface described above. In alternate embodiments, the calling information can be sent with a login request to message server 180. In further implementations, message server 180 may query a client system for the calling information.

In one embodiment, the calling information includes the following fields: 1) telephone numbers—identifying telephone numbers for desired call recipients; 2) call recipient names—identifying call recipient names corresponding to the telephone numbers; and 3) campaign identifier—identifying a campaign to deliver to the call recipients when their telephone numbers are called. In one embodiment, the telephone number must include 10 digits, with the first three digits representing an area code. In alternate embodiments, such as those supporting international dialing, the telephone number requirements are different.

Each of the above-identified calling information fields can have a variety of formats. Example telephone number formats include a list of telephone numbers entered by a client system user, a file containing a list of telephone numbers, and a pointer to a location in message server 180 where a list of telephone numbers are stored. Example call recipient name formats include a list of names entered by a client system user, a file containing a list of names, and a pointer to a location in message server 180 where a list of names are stored. Example campaign identifier formats include a file name for an audio file stored in message server 180 and an audio file, such as a .wav format file. In some embodiments, the campaign identifier also identifies the format for the audible message delivery. As described above, a variety of message delivery formats are possible, such as the following: 1) delivering the message, and 2) delivering the message and prompting a call recipient to input information.

Message server 180 stores the set of calling information (step 252). In one embodiment, control engine 182 receives the calling information and passes it to database manager 184, which stores the calling information in database 186. In alternate embodiments, database manager 184 may be eliminated and control engine 182 either directly stores calling information in database 186 or passes calling information directly to calling engine 188.

Message server 180 places calls to the telephone numbers identified in the set of calling information (step 254)—delivering the message specified by the campaign identifier. Message server 180 determines whether any errors were encountered in placing the calls (step 256). If any errors occurred, message server 180 reports the errors (step 258). In one implementation, message server 180 creates an error log and sends the log over network 100 to the client system that supplied the set of calling information. In alternate implementations, the error may only be logged.

After reporting any errors (step 258) or if no errors occurred, message server 180 determines whether any more calls need to be placed (step 260). This step is useful when the set of calling information includes more telephone numbers than the message server's automated dialer can receive at one time—some automated dialers have limits on the numbers of telephone numbers that can be presented at one time. In these instances, message server 180 places calls in batches. If more calls are needed (step 260), message server 180 returns to the step of placing calls for remaining telephone numbers (step 254). Otherwise, the calling action is done. Step 260 may be eliminated in an implementation where automated dialer 190 has no limitation on the telephone numbers that can be presented at one time.

FIG. 6 shows one version of a process performed by message serve 180 to place calls (step 254). Message server 180 creates a calling packet (step 280) that can be used by automated dialer 190 to make telephone calls. In one implementation, the calling packet contains a campaign identifier and the following fields for each call to be placed: 1) telephone number—identifying a telephone number to call; 2) first name—identifying the first name of the call recipient corresponding to the telephone number; and 3) last name—identifying the last name of the call recipient corresponding to the telephone number.

Calling engine 188 creates the calling packet by retrieving the set of calling information from database 186. In one implementation, database manager 184 queries database 186 to obtain the calling information for calling engine 188. In alternate embodiments, calling engine 188 directly accesses database 186. If further embodiments, database 186 passes the calling information directly to automated dialer 190, which stores the calling information in the calling packet format.

Client engine 188 sends the calling packet to automated dialer 190 (step 282). Automated dialer 190 calls the telephone numbers in the calling packet and delivers the message associated with the campaign identified in the calling packet (step 284).

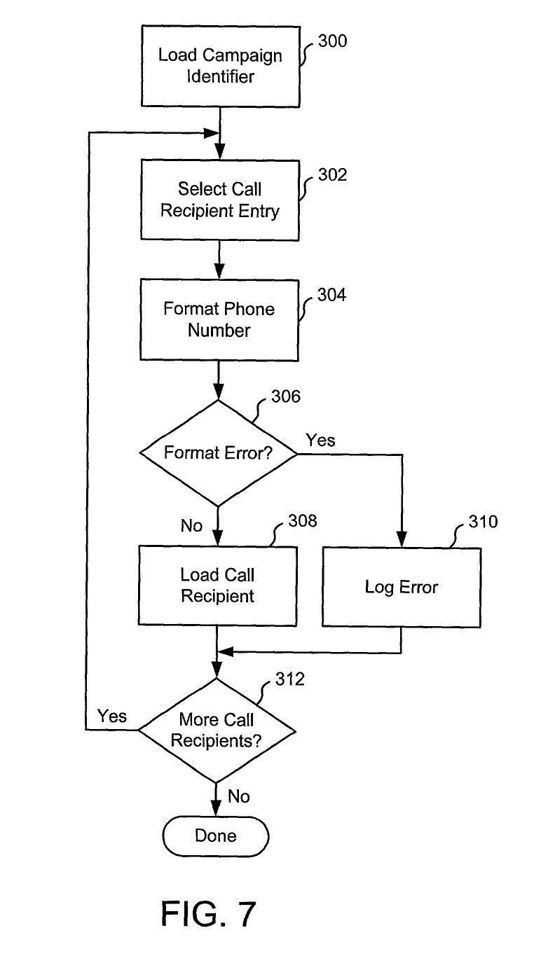

FIG. 7 shows one embodiment of a process for creating a calling packet (step 280, FIG. 6). Calling engine 188 loads the campaign identifier from a set of calling information into the calling packet. Calling engine 188 also selects a call recipient entry from the set of calling information (step 302). In one embodiment, as discussed above, the entry includes a call recipient's name and telephone number.

Calling engine 188 formats the entry's telephone number in accordance with the format required for automated dialer 190 (step 304)—creating a formatted telephone number. Greater details regarding formatting are provided below. Calling engine 188 determines whether any type of formatting error occurred (step 306). If an error did occur, calling engine 188 logs the error (step 310). Otherwise, calling engine 188 loads information for the selected entry into the calling packet (step 308). In one implementation, the entry information loaded into the calling packet is the call recipient's first and last names and the formatted telephone number.

After logging an error (step 310) or loading call recipient information (step 308), calling engine 188 determines whether any call recipients identified in the calling information have not been selected (step 312). If call recipients remain unselected, calling engine 188 selects one of the remaining call recipient entries and continues the above-identified process from step 302 on. Otherwise, the calling packet creation is complete.

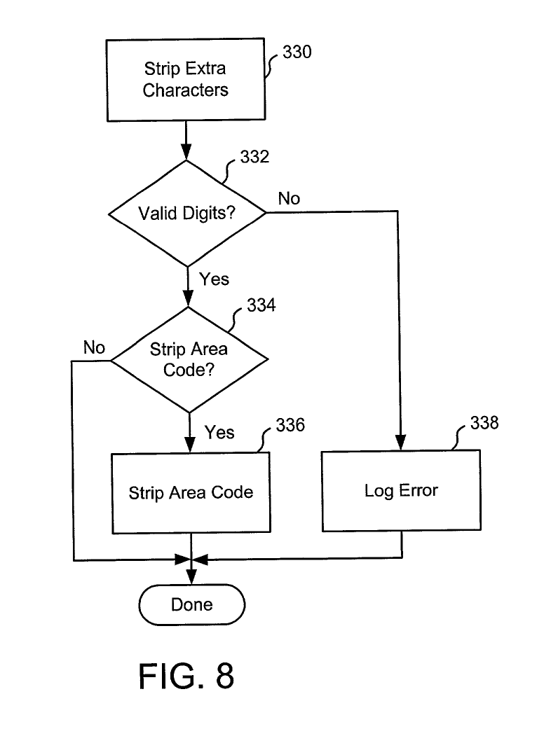

FIG. 8 shows one embodiment of a process for generating a formatted telephone number (step 304, FIG. 7). Calling engine 188 strips any extra characters out of the telephone number (step 330). Extra characters are those not required by automated dialer 190. Examples of extra characters include dashes, spaces, dots, and parentheses. In some instances, a telephone number from the calling information does not contain extra characters—resulting in no characters being stripped in step 330.

Calling engine 188 determines whether the stripped telephone number has a valid number of digits (step 332). In one implementation, the valid number of digits is 10—representing a 3 digit area code and 7 calling digits. In other applications, such as international calling, the number of digits and formatting can vary. If the number of digits is invalid, calling engine 188 logs an error (step 338) and the formatting process is done.

Otherwise, calling engine 334 determines whether the outgoing call will need an area code (step 334). An area code is needed if the formatted telephone number has an area code that differs from the area code assigned to automated dialer 190. If an area code needs to be stripped, calling engine 188 strips the area code and the formatting process is complete. Otherwise, the formatting process is complete and no stripping takes place. In alternate embodiments, message server 180 may determine whether other prefixes are required and strip these prefixes when they're not necessary. A country code is an example of another prefix. Those skilled in the art will recognize that many different formatting operations can be performed in alternate embodiments, based on the telephone number format required by automated dialer 190.

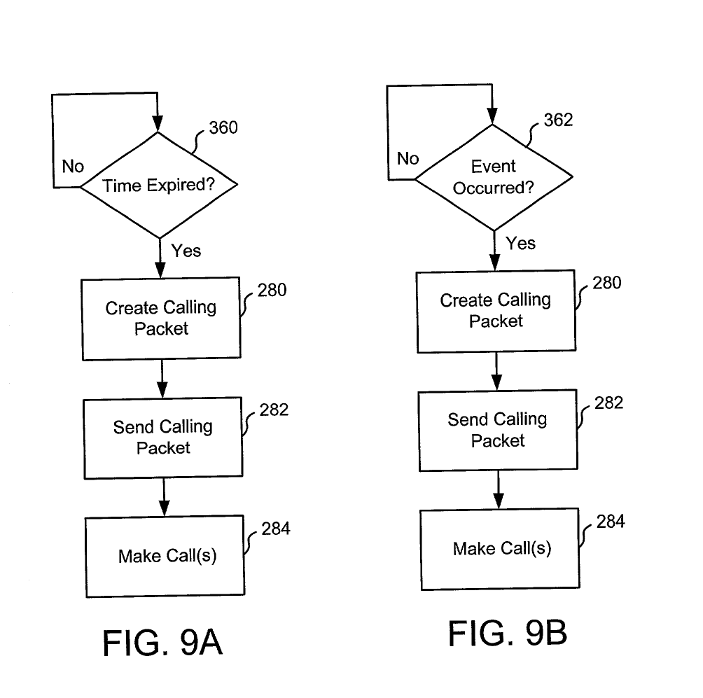

FIG. 9A is a flowchart of process steps for an alternate embodiment of placing calls (step 254, FIG. 5). The process shown in FIG. 9A allows telephone call placement to be delayed for a specified period of time. For example, a car dealer may want to send a list of customers a holiday greeting. The process in FIG. 9A allows the dealer to collect the calling information and send it to message server 180 along with a time parameter. The time parameter tells message server 180 to delay placing the calls until the specified holiday time. The process steps shown in FIG. 9A are the same as shown in FIG. 6, with the addition of message server 180 waiting for a specified time period to expire (step 360). Once the specified time period expires, message server 180 proceeds with creating and sending a calling packet (steps 280 and 282). In one implementation the specified time period is provided in the set of calling information. In alternate embodiments, different mechanisms can be employed for providing the time period to message server 180.

FIG. 9B is a flowchart of process steps for a further embodiment of placing calls (step 254, FIG. 5). The process shown in FIG. 9B allows telephone call placement to be delayed until the occurrence of a specified event. For example, a package delivery service may want to leave a phone message with a person that sends a package, to confirm the package's delivery. The process in FIG. 9B allows the delivery service to collect the calling information and send it to message server 180 along with an event parameter. The event parameter tells message server 180 to delay placing the call until the package has been delivered.

The process steps shown in FIG. 9B are the same as shown in FIG. 6, with the addition of message server 180 waiting for an event to occur (step 362). Once the specified event occurs, message server 180 proceeds with creating and sending a calling packet (steps 280 and 282). In one implementation, the event is specified in the set of calling information with an event parameter. In alternate embodiments, different mechanisms can be employed for identifying the event to message server 180.

In order to detect the event in step 362, message server 180 can employ a variety of event detection mechanisms. In one embodiment, message server 180 waits to receive a message via network 100 that the event has occurred. This message can originate from a client system or any other type of device that can transmit information over network 100. Examples include remote communication or computing devices like personal digital assistants or laptop computers. In the package delivery example, a mobile computing device carried by a package delivery person could be used to send a signal to message server 180 after a package has been delivered.

Alternatively, message server 180 can be connected to other communications networks, such as a telecommunications network, on which the event occurrence can be reported to message server 180. In a further implementation, the event is something that occurs within message server 180. Those skilled in the art recognize that many mechanisms exist for signaling an event that can be detected by message server 180.

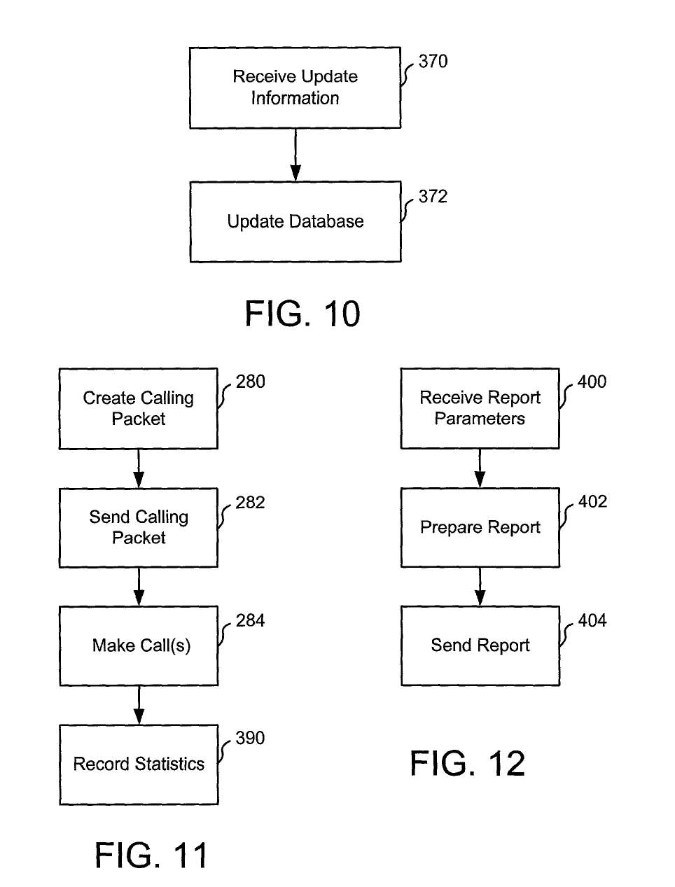

FIG. 10 shows one implementation of process steps for updating information in database 186. The process steps shown in FIG. 10 are performed as an action (step 210, FIG. 3) in response to a client system action request (step 208, FIG. 3). Message server 180 receives update information (step 370) and updates database 186 (step 372). Message server 180 receives the update information from a client system over the connection to network 100 in one embodiment. A client system user can provide the update information through the user interface provided by message server 180 (step 206, FIG. 3). Examples of update information include: 1) new categories and campaigns to add to the user's interface; 2) modifications to existing categories and campaigns in the user's interface; and 3) deletions of categories and campaigns in the user's interface.

FIG. 11 shows a flowchart of process steps for another embodiment of placing calls (step 254, FIG. 5). The process in FIG. 11 includes the same steps of creating calling packets (step 280), sending calling packets (step 282), and making calls (step 284) as shown in FIG. 6. The process in FIG. 11 further includes the step of message server 180 recording call related statistics (step 390). Example statistics include the following: 1) telephone numbers called; 2) telephone numbers answered; 3) correlations between telephone numbers called and the client systems requesting the calls. In further embodiments, many different types of statistics can be recorded. Message server 180 can employ the recorded statistics to provide statistical reports that track calls and call related information.

FIG. 12 illustrates a process that message server 180 employs to create statistical reports. In one embodiment, message server 180 performs the report process in response to an action request from a client system (steps 208 and 210, FIG. 3). Message server 180 receives parameters for the report from a client system through network 100 (step 400). The parameters can be delivered as part of a request for the report or separately. A client system user can deliver the report parameters and request through the user interface that message server 180 provides (step 206, FIG. 3).

Message server 180 prepares a report based on the received parameters and recorded call related statistics (step 402). Once the report is prepared, message server 180 sends the report to the requesting client system through network 100 (step 404). Reports can contain a variety of call related information—tracking requested and placed calls and statistics related to the calls and client systems. The reports will enable clients of message server 180 to determine how effective their telemarketing efforts have been. Trends identified in the reports may also enable clients to make adjustments that enhance the effectiveness of their marketing efforts.

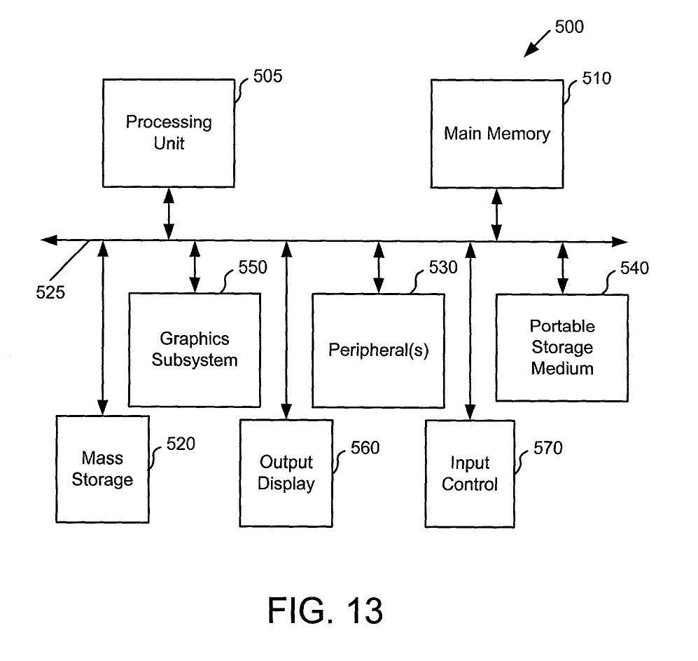

FIG. 13 illustrates a high level block diagram of general purpose computer system 500. System 500 may be employed in embodiments of the present invention as message server 180 and client systems 122, 124, 126, 142, 144, 146, 162, 164, and 166. Accordingly, computer system 500 may be employed for performing a number of processes, including those illustrated in FIGS. 3-12.

Computer system 500 contains processing unit 505, main memory 510, and interconnect bus 525. Processing unit 505 may contain a single microprocessor or a plurality of microprocessors for configuring computer system 500 as a multi-processor system. Processing unit 505 is employed in conjunction with a memory or other data storage medium containing application specific program code instructions to implement the process shown in FIGS. 3-12.

Main memory 510 stores, in part, instructions and data for execution by processing unit 505. If a process, such as the processes illustrated in FIGS. 3-12, is wholly or partially implemented in software, main memory 510 can store the executable instructions for implementing the process when the computer is in operation. For example, main memory 510 can store program code instructions employed by message server 180. In one implementation, main memory 510 includes banks of dynamic random access memory (DRAM) as well as high-speed cache memory.

Computer system 500 further includes mass storage device 520, peripheral device(s) 530, portable storage medium drive(s) 540, input control device(s) 570, graphics subsystem 550, and output display 560. In one embodiment, automated dialer 190 is included in peripheral devices 530. For purposes of simplicity, all components in computer system 500 are shown in FIG. 13 as being connected via bus 525. However, computer system 500 may be connected through one or more data transport means in alternate implementations. For example, processing unit 505 and main memory 510 may be connected via a local microprocessor bus, and mass storage device 520, peripheral device(s) 530, portable storage medium drive(s) 540, and graphics subsystem 550 may be connected via one or more input/output busses.

Mass storage device 520 is a non-volatile storage device for storing data and instructions for use by processing unit 505. Mass storage device 520 can be implemented in a variety of ways, including a magnetic disk drive or an optical disk drive. In software embodiments of the present invention, mass storage device 520 stores the instructions executed by computer system 500 to perform processes such as those illustrated in FIGS. 3-12.

Portable storage medium drive 540 operates in conjunction with a portable non-volatile storage medium to input and output data and code to and from computer system 500. Examples of such storage mediums include floppy disks, compact disc read only memories (CD-ROM) and integrated circuit non-volatile memory adapters (i.e. PC-MCIA adapter). In one embodiment, the instructions for enabling computer system 500 to execute processes, such as those illustrated in FIGS. 3-12, are stored on such a portable medium, and are input to computer system 500 via portable storage medium drive 540.

Peripheral device(s) 530 may include any type of computer support device, such as an input/output interface, to add additional functionality to computer system 500. For example, peripheral device(s) 530 may include a communications controller, such as a network interface card or integrated circuit, for interfacing computer system 500 to a communications network. Instructions for enabling computer system 500 to perform processes, such as those illustrated in FIGS. 3-12, may be downloaded into the computer system's main memory 510 over a communications network. Computer system 500 may also interface to a database management system over a communications network or other medium that is supported by peripheral device(s) 530.

Input control device(s) 570 provide a portion of the user interface for a user of computer system 500. Input control device(s) 570 may include an alphanumeric keypad for inputting alphanumeric and other key information, a cursor control device, such as a mouse, a trackball, stylus, or cursor direction keys. In order to display textual and graphical information, computer system 500 contains graphics subsystem 550 and output display 560. Output display 560 can include a cathode ray tube display or liquid crystal display. Graphics subsystem 550 receives textual and graphical information, and processes the information for output to output display 560.

The components contained in computer system 500 are those typically found in general purpose computer systems. In fact, these components are intended to represent a broad category of such computer components that are well known in the art.

The process steps and other functions described above with respect to embodiments of the present invention may be implemented as software instructions. More particularly, the process steps illustrated in FIGS. 3-12 may be implemented as software instructions. For one software implementation, the software includes a plurality of computer executable instructions for implementation on a general purpose computer system. Prior to loading into a general purpose computer system, the software instructions may reside as encoded information on a computer readable medium, such as a magnetic floppy disk, magnetic tape, and compact disc read only memory (CD-ROM). In one hardware implementation, circuits may be developed to perform the process steps and other functions described herein.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

We claim:

1. A computer implemented method for providing access to automated dialing, said method comprising the steps of:
(a) receiving calling information via a network connection, wherein said calling information identifies a set of telephone numbers;
(b) creating a calling packet; and
(c) sending said calling packet to an automated dialer.

2. The computer implemented method of claim 1, wherein said step (b) includes the step of:
(1) formatting said set of telephone numbers to generate a set of formatted telephone numbers.

3. The computer implemented method of claim 2, wherein said step (b)(1) includes the steps of:
(i) stripping extra characters in a telephone phone number in said set of telephone numbers;
(ii) determining whether there are a valid number of digits in said telephone number; and
(iii) determining whether to strip a prefix from said telephone number.

4. The computer implemented method of claim 3, wherein said step (b)(1) further includes the step of:
(iv) logging an error if said telephone number does not have a valid number of digits.

5. The computer implemented method of claim 3, wherein said step (b)(1) further includes the step of:
(v) stripping said prefix from said telephone number.

6. The computer implemented method of claim 3, wherein said steps (b)(1)(i), (b)(1)(ii), and (b)(1)(iii) are performed for each telephone number in said set of telephone numbers.

7. The computer implemented method of claim 2, wherein said step (b) further includes the step of:
(2) loading said set of formatted telephone numbers into said calling packet.

8. The computer implemented method of claim 7, wherein said step (b) further includes the steps of:
(3) loading a set of names into said calling packet, wherein said set of names corresponds to said set of formatted telephone numbers; and
(4) loading a campaign identifier into said calling packet.

9. The computer implemented method of claim 1, further including the step of:
(d) reporting any errors that occurred in said step (b).

10. The computer implemented method of claim 1, wherein said calling information includes a set of names corresponding to said set of telephone numbers.

11. The computer implemented method of claim 1, wherein said calling information further includes a campaign identifier.

12. The computer implemented method of claim 1, wherein said calling information further includes an audible message.

13. The computer implemented method of claim 1, wherein said set of calling information identifies said set of telephone numbers by including a file containing said set of telephone numbers.

14. The computer implemented method of claim 1, wherein said set of calling information identifies said set of telephone numbers by listing said set of telephone numbers.

15. The computer implemented method of claim 1, wherein said set of calling information identifies said set of telephone numbers by including a pointer to said set of telephone numbers.

16. The computer implemented method of claim 1, further including the step of:
(e) storing said calling information before performing said step (b).

17. The computer implemented method of claim 1, further including the step of:
(f) waiting for a predetermined period of time to elapse before performing said step (c).

18. The computer implemented method of claim 17, wherein said calling information identifies said predetermined period of time.

19. The computer implemented method of claim 1, further including the step of:
(g) recording statistics related to telephone calls made to telephone numbers in said set of telephone numbers.

20. The computer implemented method of claim 19, further including the step of:
(h) preparing at least one report based on said statistics recorded in said step (g).

21. The computer implemented method of claim 20, further including the step of:
(j) receiving report parameters for said at least one report via a network connection.

22. The computer implemented method of claim 1, further including the steps of:
(k) receiving update information; and
(l) updating a database in response to said update information.

23. The computer implemented method of claim 22, wherein said update information includes a campaign identifier.

24. The computer implemented method of claim 22, wherein said update information includes a category.

25. The computer implemented method of claim 1, further including the step of:
(m) providing a user interface.

26. The computer implemented method of claim 25, wherein said step (m) includes the step of:
(1) retrieving data for said user interface based on a set of identification information.

27. The computer implemented method of claim 26, further including the step of:
(n) receiving said set of identification information via said network connection.

28. The computer implemented method of claim 26, wherein said set of identification information includes a user name and a user password.

29. The computer implemented method of claim 26, wherein said data resides in a database containing unique data for a plurality of users.

30. The computer implemented method of claim 1, further including the step of:
(o) waiting for an event to occur before performing said step (c).

31. The computer implemented method of claim 30, wherein said calling information identifies said event.

32. One or more processor readable storage devices having processor readable code embodied on said processor readable storage devices, said processor readable code for programming one or more processors to perform a method for providing access to automated dialing, said method comprising the steps of:
(a) receiving calling information via a network connection, wherein said calling information identifies a set of telephone numbers;
(b) creating a calling packet; and
(c) sending said calling packet to an automated dialer.

33. One or more processor readable storage devices according to claim 32, wherein said step (b) includes the step of:
(1) formatting said set of telephone numbers to generate a set of formatted telephone numbers.

34. One or more processor readable storage devices according to claim 33, wherein said step (b)(1) includes the steps of:
(i) stripping extra characters in a telephone phone number in said set of telephone numbers;
(ii) determining whether there are a valid number of digits in said telephone number; and
(iii) determining whether to strip a prefix from said telephone number.

35. One or more processor readable storage devices according to claim 34, wherein said step (b)(1) further includes the step of:
(iv) logging an error if said telephone number does not have a valid number of digits.

36. One or more processor readable storage devices according to claim 34, wherein said step (b)(1) further includes the step of:
(v) stripping said prefix from said telephone number.

37. One or more processor readable storage devices according to claim 34, wherein said steps (b)(1)(i), (b)(1)(ii), and (b)(1)(iii) are performed for each telephone number in said set of telephone numbers.

38. One or more processor readable storage devices according to claim 33, wherein said step (b) further includes the step of:
(2) loading said set of formatted telephone numbers into said calling packet.

39. One or more processor readable storage devices according to claim 38, wherein said step (b) further includes the steps of:
(3) loading a set of names into said calling packet, wherein said set of names corresponds to said set of formatted telephone numbers; and
(4) loading a campaign identifier into said calling packet.

40. One or more processor readable storage devices according to claim 32, wherein said method further includes the step of:
(d) reporting any errors that occurred in said step (b).

41. One or more processor readable storage devices according to claim 32, wherein said calling information includes a set of names corresponding to said set of telephone numbers and a campaign identifier.

42. One or more processor readable storage devices according to claim 32, wherein said method further includes the step of:
(e) storing said calling information before performing said step (b).

43. One or more processor readable storage devices according to claim 32, wherein said method further includes the step of:
(f) waiting for a predetermined period of time to elapse before performing said step (c).

44. One or more processor readable storage devices according to claim 43, wherein said calling information identifies said predetermined period of time.

45. One or more processor readable storage devices according to claim 32, wherein said method further includes the step of:
(g) recording statistics related to telephone calls made to telephone numbers in said set of telephone numbers.

46. One or more processor readable storage devices according to claim 32, wherein said method further includes the step of:
(h) preparing at least one report based on said statistics recorded in said step (g).

47. One or more processor readable storage devices according to claim 46, wherein said method further includes the step of:
(j) receiving report parameters for said at least one report via a network connection.

48. One or more processor readable storage devices according to claim 32, wherein said method further includes the steps of:
(k) receiving update information; and
(l) updating a database in response to said update information.

49. One or more processor readable storage devices according to claim 32, wherein said method further includes the steps of:
(m) providing a user interface.

50. One or more processor readable storage devices according to claim 49, wherein said step (m) includes the step of:
(1) retrieving data for said user interface based on a set of identification information.

51. One or more processor readable storage devices according to claim 50, wherein said method further includes the step of:
(n) receiving said set of identification information via said network connection.

52. One or more processor readable storage devices according to claim 32, wherein said method further includes the step of:
(o) waiting for an event to occur before performing said step (c).

53. One or more processor readable storage devices according to claim 52, wherein said calling information identifies said event.

54. An apparatus comprising:
one or more communications interfaces;
one or more storage devices; and
one or more processors in communication with said one or more storage devices and said one or more communication interfaces, said one or more processors perform a method for providing access to automated dialing, said method comprising the steps of:
(a) receiving calling information via a network connection, wherein said calling information identifies a set of telephone numbers;
(b) creating a calling packet; and
(c) sending said calling packet to an automated dialer.

55. The apparatus of claim 54, wherein said step (b) includes the step of:
(1) formatting said set of telephone numbers to generate a set of formatted telephone numbers.

56. The apparatus of claim 55, wherein said step (b)(1) includes the steps of:
(i) stripping extra characters in a telephone phone number in said set of telephone numbers;
(ii) determining whether there are a valid number of digits in said telephone number; and
(iii) determining whether to strip a prefix from said telephone number.

57. The apparatus of claim 56, wherein said step (b)(1) further includes the step of:
(iv) stripping said prefix from said telephone number.

58. The apparatus of claim 56, wherein said steps (b)(1)(i), (b)(1)(ii), and (b)(1)(iii) are performed for each telephone number in said set of telephone numbers.

59. The apparatus of claim 55, wherein said step (b) further includes the steps of:
(2) loading said set of formatted telephone numbers into said calling packet;
(3) loading a set of names into said calling packet, wherein said set of names corresponds to said set of formatted telephone numbers; and
(4) loading a campaign identifier into said calling packet.

60. The apparatus of claim 54, wherein said method further includes the step of:
(d) reporting any errors that occurred in said step (b).

61. The apparatus of claim 54, wherein said calling information includes a set of names corresponding to said set of telephone numbers and a campaign identifier.

62. The apparatus of claim 54, wherein said method further includes the step of:
(e) waiting for a predetermined period of time to elapse before performing said step (c).

63. The apparatus of claim 62, wherein said calling information identifies said predetermined period of time.

64. The apparatus of claim 54, wherein said method further includes the step of:
(f) recording statistics related to telephone calls made to telephone numbers in said set of telephone numbers; and
(g) preparing at least one report based on said statistics recorded in said step (f).

65. The apparatus of claim 54, wherein said method further includes the steps of:
(h) receiving update information; and
(j) updating a database in response to said update information.

66. The apparatus of claim 54, wherein said method further includes the step of:
(k) providing a user interface.

67. The apparatus of claim 66, wherein said step (k) includes the step of:
(1) retrieving data for said user interface based on a set of identification information received via said network connection.

68. The apparatus of claim 54, wherein said method further includes the step of:
(o) waiting for an event to occur before performing said step (c).

69. The apparatus of claim 68, wherein said calling information identifies said event.

70. The apparatus of claim 54, wherein said apparatus is a message server.
